(19) United States
(12) Patent Application Publication
(10) Pub. No.: US 2007/0239629 A1
(43) Pub. Date: Oct. 11, 2007

(54) Cluster Trending Method for Abnormal Events Detection

(75) Inventor: Bo Ling, Norfolk, MA (US)

Correspondence Address: Dr. Bo Ling, 53 Fruit Street, Norfolk, MA, 02056, US

(73) Assignee: Bo Ling, Norfolk, MA (US)

(21) Appl. No.: 11/308,596

(22) Filed: Apr. 10, 2006

(51) Int. Cl. G06F 15/18

(52) U.S. Cl. 706/12

(57) ABSTRACT

A method and system is provided for detecting abnormal events by utilizing cluster trending construction and analysis mechanism. Two cluster profiles can be constructed: normal profile constructed during system normal operations; and real-time profile constructed during the actual operation of the system being monitored. This method can be used in many applications, including equipment failure detection, control loop performance assessment, plan monitoring, military target detection, etc.

This non-provisional application claims benefit of the earlier provisional application US60/670532.

### REFERENCE CITED

Frank, P. M., (1996): “Analytical and qualitative model-based fault diagnosis—a survey and some new results”, Europ. J. Contr., 2, 6-28, 1996.
Isermann, R., (1997): “Supervision, fault-detection and fault-diagnosis—an introduction, Control Eng. Practice, 5, (5), 639-652, 1997.
Ling, B., Dong, S., Venkataraman, U. (2005a): “Cluster trending analysis for control loop assessment and diagnosis”, IEE Journal of Computing and Control Engineering, August/September Issue, 2005.
Ling, B. (2005b): “A Cluster Trending Method for Abnormal Events Detection”, U.S. Provisional Patent US60/670,532.
Reichard, M. K., Dyke, M. V., Maynard, K. (2000): “Application of sensor fusion and signal classification techniques in a distributed machinery condition monitoring system”, Proceedings of SPIE, Vol. 4051, 2000.
Willsky, A. S. (1976): “A survey of design methods for failure detection in dynamic systems”, Automatica, 12, 601-611, 1976.

### BACKGROUND OF THE INVENTION

(1) Field of the Invention

The present invention generally relates to a new method to capture the dynamic variation of the sensing data by utilizing the cluster trending analysis. This invention more particularly relates to computer and/or electronic methods and systems for detecting abnormal events such as equipment faults and system performance degradation.

(2) Background Information

High degree of reliability is required in any automated systems, which requires a health monitoring system capable of detecting any equipment faults as they occur and identifying the faulty components. Component fault detection has been the subject of numerous studies in the past few decades. Initial work in this area employed a variety of paradigms to both detect and characterize faults, including signal-based, model-based and knowledge-based approaches (Willsky, 1976, Isermann, 1997, Frank, 1996). These methods have proven very successful whenever cost-benefit economics have allowed for the considerable effort involved in developing applications. Traditional time-based machinery maintenance is being replaced by maintenance based on the condition of the machinery (Reichard, et al., 2000). Under condition-based maintenance, parts and components are replaced only when they can no longer operate at the desired capacity or load, or when the machine will not be able to operate long enough to complete its current mission.

A problem in model-based fault detection is how to avoid false alarms that might be provoked due to the presence of modeling errors in residues. A simple way to avoid false alarms is to set high enough thresholding level in the residue evaluation stage. This, in turn, decreases the sensitivity of the detector with respect to faults. A better approach to avoid false alarms is through the combination of both analytical model and statistical model. It is believed that the statistical hypothesis tests, together with feature-based trend analysis over time series data, can effectively assist the maintenance decision-making. In the present invention, a new method used for the equipment health monitoring (Ling 2005a) is disclosed. This invention disclosure is also based on U.S. Provisional Patent US60/670532 (Ling 2005b). This method is based on the cluster trending analysis which is very sensitive to small signal variations and capable of detecting the abnormal signals embedded in the normal signals.

### SUMMARY OF THE INVENTION

In one aspect, the present invention includes a method to segment the continuous sensing data. This method includes the cluster window construction and window size estimation. The method also includes the estimation of a jump step. The combination of cluster window and jump step can be used to extract the raw sensing data into small segments and estimate the number of clusters associated with the data in these segments.

In another aspect, this invention includes a method to estimate the number of clusters in the data segment without any prior knowledge of the data variations. In particular, the machine learning based clustering method is preferred. This method also includes a method to construct the cluster trend which will be further used to infer the health conditions of the equipment being monitored.

In yet another aspect, this invention includes a method to statistically compare the real time cluster trend profile and normal cluster trend profile to determine whether or not there is a significant deviation between these two cluster trend profiles. This method also includes a method to determine a potential of abnormal event which can be used to infer the health of the equipment being monitored.

In still a further aspect, this invention includes a method to further validate whether or not the equipment is operating in faulty conditions. In particular, this method includes a method to evaluate the density of a group of faulty indicators obtained from a sequence of abnormal event indicators generated through the statistical hypothesis tests. This method can eliminate a large number of false abnormal events.

### BRIEF DESCRIPTION OF THE DRAWING

FIG. 1 is a block diagram of the overall system architecture using the present invention detailed in this disclosure.

FIG. 2 is a block diagram of major components closely related the present invention.

FIG. 3 shows a typical sensing signal of one embodiment of the data device portion of the system shown in FIG. 2.

FIG. 4 shows the window and jump step of one embodiment of the signal segmentation portion of the system shown in FIG. 2.

FIG. 5 shows the clusters and cluster trend of one embodiment of the cluster trend construction portion of the system shown in FIG. 2.

FIG. 6 shows the cluster trends comparison of one embodiment of the statistical hypothesis test portion of the system shown in FIG. 2.

FIG. 7 shows the cluster density evaluation of one embodiment of the abnormal event indication portion of the system shown in FIG. 2.

### DETAILED DESCRIPTION

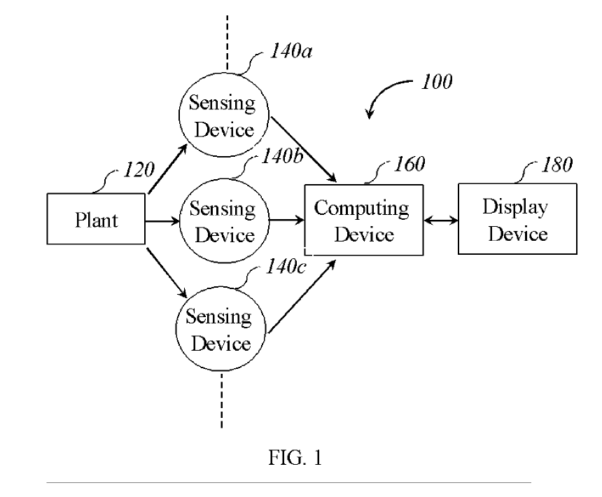

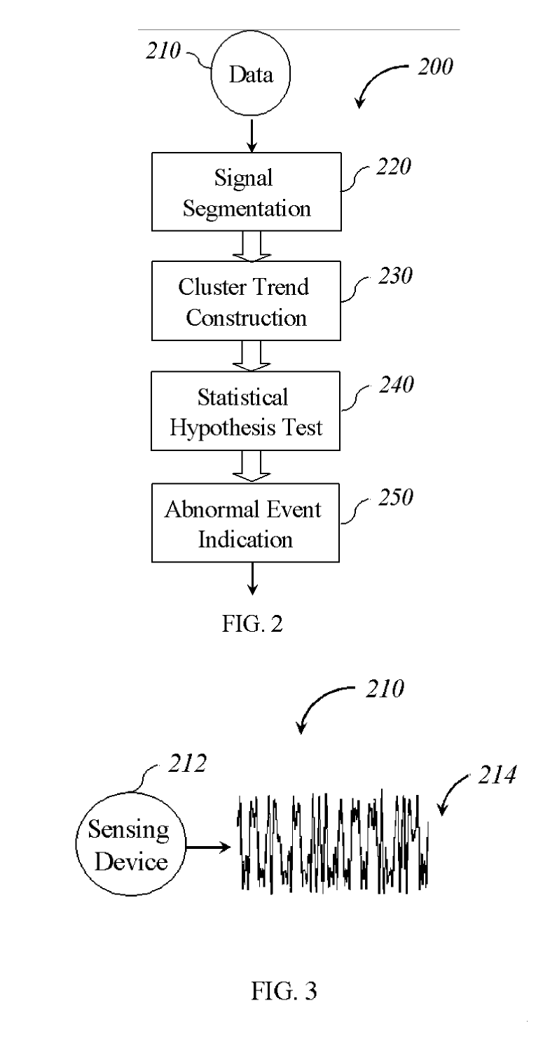

FIG. 1 shows the overall system structure 1 00 utilizing the invention in this disclosure. The plant 120 is referred to as a physical system being monitored, which can include any systems such as equipment, machine, etc. The invention can be used to monitor the physical health of the plant 120. A set of sensing devices 1 40 are used to measure the physical characteristic properties of the plant 120, which can be vibration, temperature, voltage, current, etc. The sensing device can be as simple as a vibration sensor, or as complex as a spectrometer. The measurement data from the sensing devices 140 are transmitted to the computer device 1 60, through either wired or wireless communication. A typical computing device 1 60 can be an industrial PC running real-time operating system such as Microsoft Windows CE. A display device 1 80 can be connected to the computing device 1 60 through either wired or wireless communication. This display device 1 80 can be used to show measurement data, alarms, configuration, etc. The invention in this disclosure is primarily developed to detect so-called abnormal event (for example, an abnormal event can be an equipment malfunctioning). There are four major components in this detection system, which are shown in FIG. 2. The Data 210 represents the measurement from a sensing device 212. As shown in FIG. 3, this sensing device generally produces a continue output signal. This continuous signal 214 is generated by the sensing device 212. For example, such signal can be temperature or vibration. The invention detailed here is directly applied to this continuous signal which can be the raw signal (not filtered) or filtered signal. Signal filtering is not part of this invention.

Signal Segmentation

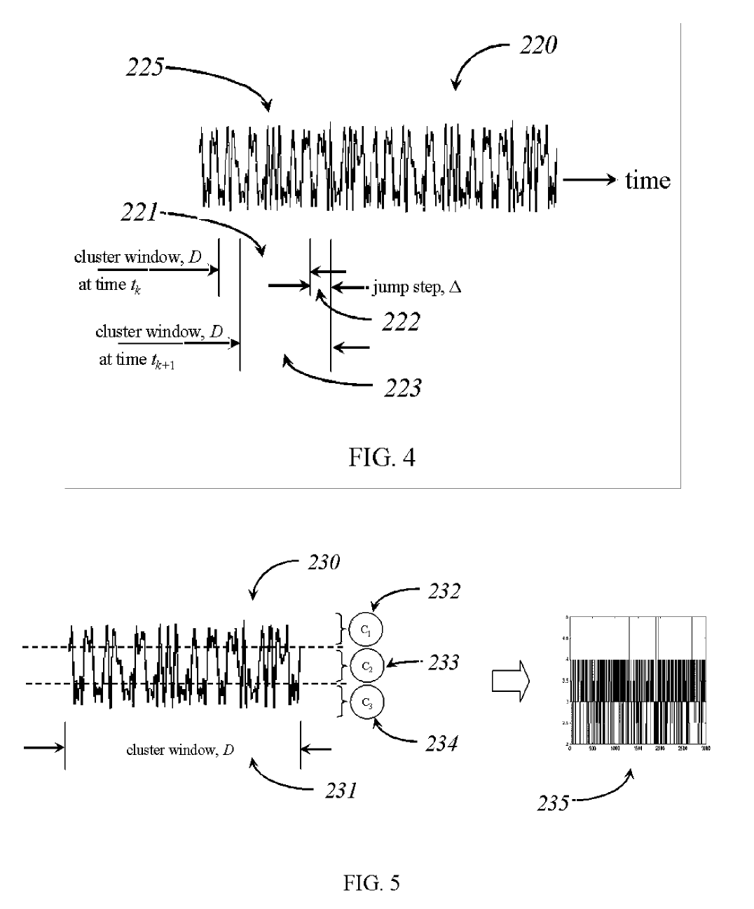

Refer to FIG. 4. The raw sensor measurements 225 are segmented based on a moving window 221 with its size determined a priori from the normal data. This window size, D, can be determined based on the data correlation. For the real time or near real time diagnosis, the value of D should be chosen to balance the detection accuracy and the computation time. For example, the window size D can be chosen as 200˜300 data points. In each window 221, the number of clusters is automatically estimated based on a machine learning scheme. An unsupervised clustering method must be used since there is usually no any knowledge about the number of clusters in each data segment with the length equal to the window size, D. At sampling time tₖ, the previous D-1 data points and the current measurement can be used to form a data segment of size D. At next sampling time tₖ₊₁, the same technique can be used to form a new data segment with D data points. In this fashion, there are D-1 data points overlapped in these two data segments obtained at both sampling time tₖ and tₖ₊₁. Since the data variations in each data segment are different, a number of data points, called jump step 222, can be skipped. The value of jump step Δ 222 can be estimated by calculating the auto-correlation of the data in the data segment. Using this jump step Δ, instead of forming this data segment at each sampling time, the data segment at sampling time with increment of Δ, i.e., tₖ, t_{k+Δ}, t_{k+2Δ}, . . . , is obtained. The value of Δ can be estimated dynamically using the normal measurement data. The estimation method must incorporate the data variation in each data segment. Once this jump step Δ has been estimated from the normal data, the same value will be used in the real time equipment monitoring. If n sensing devices are used, then n jump steps must be estimated. Each of these jump steps will be used for related sensing data.

Cluster Trend Construction

The equipment diagnosis method detailed in this invention requires two profiles: normal cluster trend profile and actual cluster trend profile. They are constructed based on the normal data and real time measurement data. Since the cluster trend profile construction procedure is the same for both normal cluster trend and actual trend, in this disclosure, only the method with which a cluster trend (normal or actual) is constructed will be detailed.

Suppose {xₖ, k=1, 2, . . . , ∞} is a time sequence from the sensor measurement, where k represents the time instant at kth sampling time. One example of such signal is shown in FIG. 4. Refer to FIG. 5. Consider the data segment of size D 231 based on the procedure detailed under Signal Segmentation above. In other words, {xₖ, k=1, 2, . . . , D} will be processed to estimate the number of clusters in this data segment. There exist a large number of clustering algorithms. The choice of clustering algorithm depends on the type of data available and on the particular purpose and application. There are many different ways to express and formulate the clustering problem, as a consequence, the obtained results and its interpretations depend strongly on the way the clustering problem was originally formulated. Most existing clustering algorithms require the prior knowledge of the number of clusters in the data. These clustering methods cannot be used here since the actual number of clusters solely depends on the data variation. For example, when an equipment operating in faulty conditions, its sensing data deviates considerably from the normal data. Therefore, a machine learning based clustering method must be used. In this disclosure, the actual clustering method is not part of this invention although the inventors of present invention have been using a neural network based clustering algorithm called ASOM (Adaptive Self-Organizing Maps).

This similarity-based ASOM allows the feature map to be evolved quickly and acquires topological representation simultaneously. ASOM avoids the time complexity of searching for neighborhood ranking and is free of the constraint of a low dimensional map topology. It starts with a null network and gradually allocates new prototypes when new data samples can not be matched well onto existing prototypes. A new node is inserted using exactly the poorly matched input vector. More importantly, ASOM will learn itself over the time. It has the following unique features: (1) a similarity measurement based prototype matching; (2) automatic learning of number of nodes (clusters) without any prior knowledge; and (3) boundary points alignment for robust clustering. Refer to FIG. 5 again. Based on the intelligent clustering method, for the data segment 231, there are three clusters, C₁ 232, C₂ 233, and C₃ 234. Therefore, for this data segment, the number of clusters is 3.

So far it has been described how to estimate the number of clusters, cₖ, in a data segment obtained at sampling time tₖ. One again, the actual clustering method is not part of this invention. At sampling time t_{k+Δ}, where Δ is the jump step, shown in FIG. 4, based on the same cluster number estimation procedure detailed above, a new data segment can be obtained and the number of clusters, c_{k+Δ}, in this data segment, can be estimated. In this way, as time goes on, a sequence of cluster numbers can be constructed, which is called a cluster trend profile 235.

Statistical Hypothesis Test

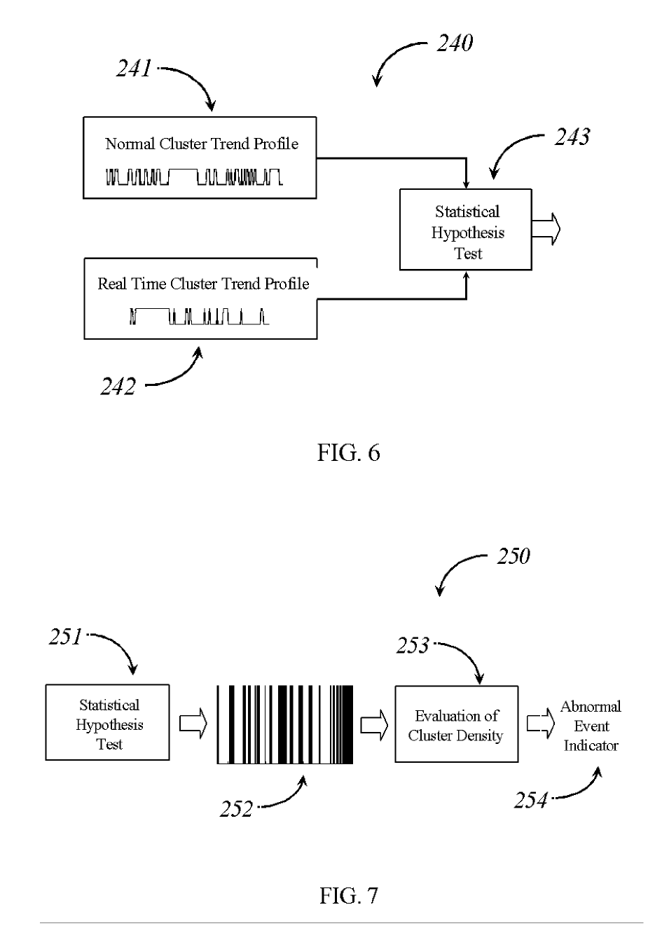

Similar to the normal cluster trend profile construction as shown in FIG. 5, for the real-time sensing measurement, a cluster trend 242 as shown in FIG. 6, can be constructed. To detect the abnormal event, this real time cluster trend is statistically compared with the normal cluster trend profile 241 as illustrated in FIG. 6. There are many methods used to statistically compare the deviation between actual and normal cluster trends. The statistical method used for the hypothesis test 243 is not part of this invention. Since the cluster trend disclosed in this invention is discrete, i.e., this cluster trend has only discrete numerical values such as 2, 3 or 4, etc., parametric method, which requires data modeling based on certain assumptions of underlying data distributions, may not be the best choice. Instead, a non-parametric statistical method such as Kolmogorov-Smirnov Test is recommended.

As an example, the likelihood ratio test (LRT) can be used. Specifically, two predictive statistical distributions of observed xₙ, namely, pₙₒᵣₘₐₗ(xₙ|Xₙ₋₁) and p_{fault}(xₙ|Xₙ₋₁), are estimated. The abnormal event is detected by rejecting the null hypothesis via LRT. If the real time cluster trend profile is statistically significantly different from the normal cluster trend profile, the equipment has deviated from its normal operation conditions, thus, the operating under faulty conditions. The statistical hypothesis test 243 produces an abnormal event indicator with binary values, 0/1 or FALSE/TRUE. In other words, the abnormal event indicator is set to TRUE (1) if two cluster trends are statistically significantly different over a period of time.

Abnormal Event Identification

Since certain momentary disturbance can cause the deviation of actual and normal cluster trends, the statistical hypothesis test alone is not sufficient to eliminate the false abnormal events. Refer to FIG. 7. Based on the real time cluster trend and normal cluster trend, the statistical hypothesis test 251 is performed. If these two cluster trends are statistically and significantly different, a binary value 1 is set as an indication of data pattern deviation. If these two cluster trends are statistically similar, a binary value of 0 is given. As time goes on, a sequence of 0s or 1s 252 can be obtained. Each binary value of 1 can be used to infer a potential abnormal event at one particular time instance. If the equipment being monitored is operating under faulty conditions, a sequence of consecutive 1s can be observed (for example, the last portion of indicators 252 shown in FIG. 7). These clusters of 1s can be characterized by the density of 1s in a smaller window, which can be further used to reduce the false abnormal events. This procedure 253 is shown in FIG. 7. For example, if the sampling time is 100 ms and the step jump Δ 222 is 1, a small window of 100 points, equivalent to 10 seconds of observations, can be used to evaluate the density of 1s.

In this disclosure, the density of 1s over a small window can be used to further analyze the equipment health. There are many different ways to evaluate this density. The method used is not part of this invention. For example, the entropy of 1s in this small window can be used to estimate the energy contained in a group of 1s. If the entropy is greater than certain threshold level determined a priori, the abnormal event indicator 254 can be set to value of 1, which implies the existence of malfunctioning of the equipment being monitored. Another simple way to evaluate the cluster density is to count the number of 1s in the window and calculate the ratio between the number of 1s and the total number of data points in the window. If this ratio is larger than a predefined threshold value, the abnormal event indicator 254 can be set to value of 1. For example, the threshold value can be set as 2/3, which means that the abnormal event indicator 254 will be set to value of 1 if there are 2/3 of data points with value of 1. This procedure can be viewed as a majority voting.

Although this invention has been described according to an exemplary embodiment, it should be understood by those of ordinary skill in the art that modifications may be made without departing from the spirit of the invention. The scope of the invention is not to be considered limited by the description of the invention set forth in the specification, but rather as defined by the claims.

What is claimed is:

1. The way that cluster trend is used to detect the abnormal events is unique and new. In particular, a moving window is used to segment the data and the number of clusters in this window is estimated based on unsupervised machine learning mechanism such as ASOM (Adaptive Self-Organizing Maps).

2. The way that normal cluster trend profile is constructed. Specifically, a portion of the total normal data is used to construct the normal profile. The thresholding level is estimated based on the entropy and a small portion of remaining normal data. The thresholding reflects two properties of event indicators: how dense of the indicators within one window, and if there is a large gap between two groups of indicators.

3. The way that the normal cluster trend profile and actual trend are statistically compared to determine the existence of abnormal events. Theoretically, any statistical hypothesis test algorithms can be used to trigger the abnormal event indicator. Practically, speed and computation complexity must be factored when choosing the method.

4. The way that the number of clusters is used for the detection of abnormal events. Basically, the number of clusters is used as the features associated with the raw data. As the cluster window moves, a sequence of number of clusters is obtained. This sequence of cluster numbers can be treated as a vector or a time series. This vector or series is protected under this patent.

5. Although the present invention only describes the cluster trend in 1D application, i.e., detecting the abnormal event from a single variable. The same logic is valid for multi-variables. For multiple variables, a multi-dimensional clustering algorithm such as multi-dimensional ASOM can be used to estimate the number of clusters in a moving window. The detection procedure detailed here can be used without any changes.

6. When dealing with multi-dimensional data, the cluster trending method can be used to detect the abnormal events embedded in multiple variables. They are grouped together to form a multi-dimensional data vector which is used for clustering. Once abnormal events are detected, the same procedure can be applied to individual variable to identify the source of abnormal events.

7. The event indicators don't have to be binary (0 or 1). For certain applications (e.g., data fusion) where continuous values of indicators are desired, the statistical confidence band or other continuous values such as p-value can be used as the indicator values. Sometimes, both continuous or binary values can be mixed to achieve a better detection results.

8. To reduce the false alarms (both positive or negative), this cluster trending based detection method can be combined with some other specialized classification methods. In this case, the cluster trending detection method disclosed here will provide the potential abnormal events. Some specialized classifiers can utilize various features to further discriminate the abnormal events from nuisance events. These features can be any features suitable for the classifiers chosen.

9. This clustering trending method does not have to apply to the raw data. Filtered data can be definitely used. It can be applied to image pixel values. It can also be applied to other data such as features (Fourier, wavelet, etc.). It can also be applied to mixed data (different raw data, different features, etc.). In general, any data with sequential behavior can be used.
